(19) United States
(12) Patent Application Publication
(10) Pub. No.: US 2014/0337099 A1
(43) Pub. Date: Nov. 13, 2014

(54) Identifying and Facilitating Hospitality Customer Needs

(71) Applicant: Marco Ignacio, Jacksonville, FL (US)

(72) Inventor: Marco Ignacio, Jacksonville, FL (US)

(21) Appl. No.: 14/274,070

(22) Filed: May 9, 2014

Related U.S. Application Data
(60) Provisional application No. 61/821,780, filed on May 10, 2013.

(51) Int. Cl. G06Q 30/02; G06Q 50/12; G06Q 30/00

(52) U.S. Cl. CPC G06Q 30/0203; G06Q 30/016; G06Q 50/12
USPC 705/7.32

(57) ABSTRACT

Systems, methods and computer program products for providing customized customer service and ensuring appropriate gratuity payment in hospitality environments are disclosed. In an aspect, customers may provide information about the service level they request from their server or other hospitality worker and motivate the server by indicating an associated minimum tip level. This platform serves to motivate the hospitality worker while ensuring that the customer receives service they consider quality.

### CROSS REFERENCE TO RELATED APPLICATION

This application claims the benefit of U.S. Provisional Patent Application Ser. No. 61/821,780, filed May 10, 2013, and entitled “Identifying and Facilitating Hospitality Customer Needs,” the entire contents of which are incorporated herein by reference.

### FIELD OF THE DISCLOSURE

The present disclosure generally relates to hospitality industry service and more particularly to systems, methods and computer program products for facilitating delivery of customer-specified service in a hospitality setting.

### BACKGROUND

The statements in this section merely provide background information related to the present disclosure and may not constitute prior art.

The interaction between a hospitality industry worker and customer is the core of the hospitality experience, yet each interaction is unique and often occurs in a setting where the hospitality industry worker knows little, if anything, about the customer's needs and expectations. If, for example, a server is too solicitous or too aggressive in attempting to upsell appetizers to a customer, the customer may become irritated, leave a poor gratuity and never come back to the restaurant. The same level of solicitousness may be desired by other customers, however, resulting in a positive experience for such customers, a larger gratuity for the server, and a recurring customer for the restaurant. Successful identification of the desired level of service for each customer is key to growing and maintaining a business in the hospitality industry.

Currently, some establishments, such as the Bubba Gump Shrimp Co. Restaurant & Market® chain of restaurants (available from Paramount Picture Corporation of Hollywood, Calif.) provide customers with physical signs to indicate to servers when they require assistance. This partially alleviates the burden of determining the level of service required by the customer because it provides some real-time knowledge of a customer's needs and service level desires. It does not provide such information in advance, therefore the server must still attempt to divine a customer's needs based on initial interactions.

Obtaining and acting on such information may ensure that hospitality industry workers maximize the gratuity received from the customer. The livelihoods of virtually all hospitality industry workers, including wait staff, bartenders, and taxi drivers, depend on consistent tipping because gratuities make up the majority of such workers compensation. Gratuities are intended to compensate the server for the service he or she provides, not provide a monetary commentary on the entire dining experience. For example, the most attentive and skilled server cannot correct a poorly executed entrée, nor should the server be judged for aspects of the dining experience that are beyond his control. Additional factors impede a server's ability to assess the needs of a particular customer including: how busy the establishment is; and other customers making unreasonable demands. Such factors also impede the hospitality industry worker's ability to determine the pacing, solicitousness, and overall level of service expected by a customer, jeopardizing delivering an excellent experience for the customer.

Hospitality industry worker motivation also jeopardizes the customer's experience. Gratuities are typically given after the conclusion of service and are highly variable, reducing their ability to motivate the hospitality industry worker to provide excellent service. For example, restaurant customers may pay between 10% of the pre-tax bill and 20% of the bill after tax for the services rendered by a server during the meal, based on subjective, arbitrary, and private analysis of the server's performance. Lack of knowledge of how much gratuity a customer is willing to pay for quality service, as well as how a customer defines such service, undermines the hospitality industry worker's motivation to deliver quality service.

Given the foregoing, systems, methods, and computer program products are needed which facilitate informing a hospitality industry worker of the level of service expected by a customer. In particular, informing hospitality industry workers in advance of a customer's expectation in attentiveness, solicitousness, and other factors are needed. Systems, methods, and computer program products which allow the customer to communicate more immediate needs during service are also needed.

Additionally, systems, methods, and computer program products that inform a hospitality industry worker of the amount of gratuity they can expect to receive based on a given level of service provides to the customer are needed.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products for facilitating the communication of service level expectations and corresponding gratuity payments between a customer and a hospitality industry worker before service commences and during service.

In an aspect, a mobile device-based application is provided which encourages customers to promise a minimum gratuity for service received at a hospitality establishment, such as a restaurant. Both customers and hospitality industry workers may utilize such applications. The customer inputs the minimum gratuity and service level criteria. Service level criteria may include: the number of times the customer would like to be checked up on throughout the meal; whether the customer would like recommendations for entrees; or “pet-peeves” the customer does not want to experience during service. Customer-provided gratuity and service information may be provided to the hospitality industry worker on a mobile device used by the hospitality industry worker equipped with an application in accordance with the present disclosure. Receipt of this information serves two functions, both of which facilitate a more enjoyable, customized experience for the customer: it educates the server on the customer's expectations; and motivates hospitality industry worker because they have a more clearly defined financial incentive to deliver excellent service. Upon completion of service conforming with customer-provided service level criteria, the hospitality industry worker may receive a gratuity greater than or equal to the gratuity criteria initially provided.

In an aspect, systems, methods, and computer program products in accordance with the present disclosure enable customers to inform hospitality industry workers or other employees of a hospitality establishment of immediate needs such as a refill or condiment requests via inputting the request using a mobile device. The request may be sent to a second mobile device used by the hospitality industry worker, who may then respond to the request, thereby facilitating delivery of excellent service. The hospitality industry worker may be informed of such requests by audio, visual, or physical (e.g., vibration) alerts generated by a mobile device.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating communication of service level expectations and corresponding gratuity payments between a customer and a hospitality industry worker, according to an aspect of the present disclosure.

FIG. 2 is a flowchart illustrating an exemplary process for communicating the service level expectations of a customer to a hospitality worker, according to an aspect of the present disclosure.

FIG. 3 is a flowchart illustrating an exemplary process for a hospitality industry worker to execute service based on received service level expectations, according to an aspect of the present disclosure.

FIG. 4 is a flowchart illustrating an exemplary process for a hospitality industry worker to execute service based on received service requests, according to an aspect of the present disclosure.

FIG. 5 is a block diagram of an exemplary computing system useful for implementing aspects of the present disclosure.

### DETAILED DESCRIPTION

The present disclosure is directed to systems, methods, and computer program products for facilitating the communication of service level expectations and corresponding gratuity payments between a customer and a hospitality industry worker before service commences and during service. Aspects of the present disclosure facilitate delivery of hospitality service tailored to a specific customer via incentivizing the hospitality worker providing such service.

Aspects of the present disclosure provide systems, methods, and computer program products are configured to encourage customers to specify a desired level of service and to promise a minimum gratuity in exchange for receiving that service at a hospitality establishment, such as a restaurant.

The terms “hospitality establishment” or “establishment” and/or the plural form of these terms are used interchangeably throughout herein to refer to, without limitation: restaurants, bars, pubs, cafes, diners, taxi cabs, limousines, liveried car services, theme parks, cruise ships, hotels, night clubs, and the like.

The terms “hospitality industry worker” or “hospitality worker” and/or the plural form of these terms are used interchangeably throughout herein to refer to, without limitation: individuals employed at hospitality establishments, bartenders, servers, taxi drivers, housekeepers, porters, managers of hospitality establishments, and the like. A hospitality worker may be an individual having a primary work task of providing service directly to customers (e.g., a server in a restaurant), or a hospitality work may be an individual responsible for overseeing individuals who provide service directly to customers (e.g., a restaurant manager).

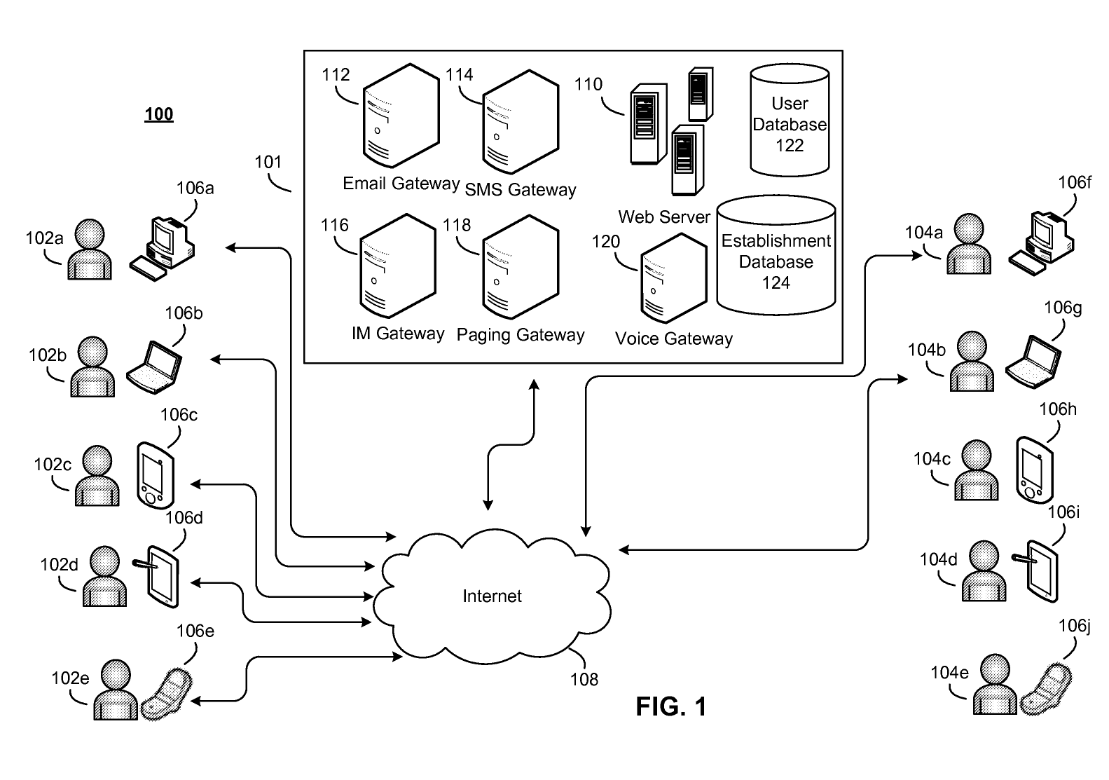

Referring now to FIG. 1, a block diagram of an exemplary system 100 for facilitating communication of service level expectations and corresponding gratuity payments between a customer 102 and a hospitality industry worker 104, according to an aspect of the present disclosure, is shown.

Cloud-based, Internet-enabled device communication system 100 includes a plurality of customers 102 (shown as users 102a-e in FIG. 1) and hospitality industry workers 104 (shown as workers 104a-e in FIG. 1) accessing—via a computing device 106 (shown as respective computing devices 106a-j in FIG. 1) and a network 108, such as the global, public Internet—an application service provider's cloud-based, Internet-enabled infrastructure 101. User 102 may access infrastructure 101 via, for example, computing device 106 in order to facilitate communication of service level expectations and gratuity payment expectations between user 102 and hospitality worker 104. Computing device 106 may be a mobile device or it may be a kiosk comprising computing functionality. Hospitality worker 104 may access infrastructure 101 via, for example, computing device 106 in order to receive service level expectations input by user 102, receive gratuity payment expectations input by user 102, and receive notices of immediate needs of customer 102 (e.g., a refill request).

In various aspects, computing device 106 may be configured as: a desktop computer 106a; a laptop computer 106b; a Personal Digital Assistant (PDA) or mobile telephone 106c; a tablet or mobile computer 106d; a cellular telephone 106e; any commercially-available intelligent communications device; or the like. System 100 may further comprise printing devices such as inkjet, thermal, or laser printers (not shown in FIG. 1).

As shown in FIG. 1, in an aspect of the present disclosure, an application service provider's cloud-based, communications infrastructure 101 may include one or more web servers 110, an email gateway 112, an SMS gateway 114, an Instant Message (IM) gateway 116, a paging gateway 118, a voice gateway 120, a user database 122, and an establishment database 124.

User database 122 may be configured to store data collected from customers 102 and hospitality workers 104. Data collected from customers 102 may include customer preferences regarding hospitality worker attentiveness; obtrusiveness; number of times hospitality worker 104 checks in with customer 102 during the course of service; customer desire to receive recommendations regarding food or drink choice; allergies and/or diet restrictions; and the like. Collected data may also include information regarding special occasions and request such as the customer being on a date; a desire for a quick lunch; the customer celebrating a special event; the customer being with business colleagues; and the like. Such information may be represented by a number (e.g., a number between zero and five) or other indicator (e.g., location of a slider on a scale, marking a check box, inputting text, etc.) input by customer 102 which represents the level of attention they desire. One or more of the above preferences may be generalized an input as a table maintenance level. Customers 102 may indicate they would like a low, medium, or high table maintenance level.

Data collected may also include an amount of gratuity customer 102 is willing to pay if hospitality worker 104 provides service consistent with customer preference. The gratuity amount specified may be a percentage gratuity (e.g., 18%), a value amount (e.g., $10), or a range (e.g., 12 to 25%, $5 to $10).

Customer 102 may also provide a rating of one or more hospitality workers 104 customer 102 interacts with. In an aspect, the rating is provided after the conclusion of service.

Data collected from hospitality workers 104 may include the typical level of attentiveness hospitality worker 104 normally provides. Such information may be self-reported by hospitality worker 104, provided by a manager of hospitality worker 104, aggregated based on third-party reviews of hospitality worker performance, or a combination thereof. Data collected may also include information on what level of service hospitality worker 104 is willing to provide in exchange for a specified gratuity amount. For example, if attentiveness is rated on a zero to five scale, hospitality worker 104 may specify that for a minimum gratuity amount of 12%, hospitality worker 104 is willing to provide service at a level three of attentiveness.

In an aspect, infrastructure may comprise establishment database 124. Establishment database 124 contains information about one or more establishments, such as menu, location, rating (including third-party quality ratings), hours of operation, and the like. Establishment database 124 may be physically separate from user database 122, logically separate, or physically or logically indistinguishable. In alternate aspects, user database 122 or establishment database 124 may comprise one or more data stores within (or remotely located from) infrastructure 101 or be a memory included in (or coupled to) web server 110.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 108. Thus, system 100 is scalable.

As will also be appreciated by those skilled in the relevant art(s), in an aspect, various screens would be generated by server 110 in response to input from customers 102 and hospitality workers 104 over Internet 108. That is, in such an aspect, server 110 is a typical web server running a server application at a website which sends out webpages in response to Hypertext Transfer Protocol (HTTP) or Hypertext Transfer Protocol Secured (HTTPS) requests from remote browsers on various computing devices 106 being used by various customers 102 and hospitality workers 104. Thus, server 110 is able to provide a graphical user interface (GUI) to customers 102 and hospitality workers 104 of system 100 in the form of webpages. These webpages are sent to the user's PC, laptop, mobile device, PDA or like device 106, and would result in the GUI being displayed.

As will be appreciated by those skilled in the relevant art(s) after reading the description herein, alternate aspects of the present disclosure may include providing a tool for facilitating the communication of information from management component 122 to devices 106 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where hospitality workers 104 are all personnel/employees of the same company and customers 102 are all visiting establishments owned or operated by such a company, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating communication of service level expectations and corresponding gratuity payments between customer 102 and hospitality industry worker 104 before service commences from infrastructure 101 to devices 106 via a browser pre-installed with an applet or a browser with a separately downloaded applet on such devices 106. That is, as will also be apparent to one skilled in the relevant art(s) after reading the description herein, the applet that facilitates the charging station platform disclosed herein, may be part of the “standard” browser that ships with computing device 106 or may be later added to an existing browser as part of an “add-on,” “plug-in,” or “app store download.”

The terms “customer,” “user”, and/or the plural form of these terms are used interchangeably throughout herein to refer to those persons or entities capable of accessing, using, being affected by and/or benefiting from the tool that the present disclosure provides.

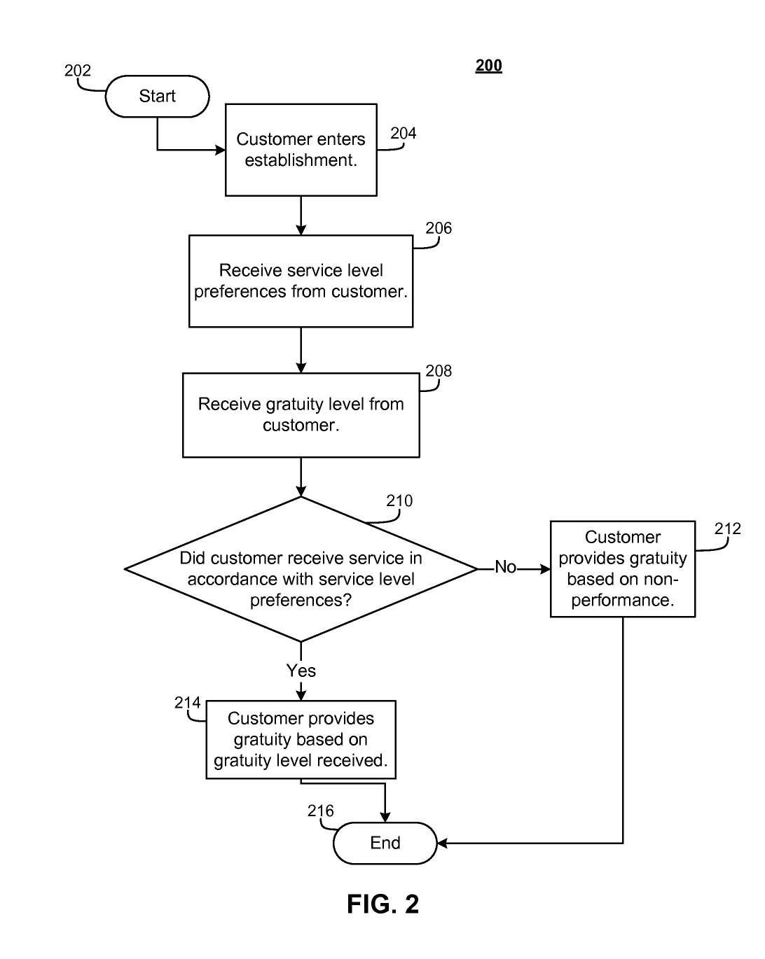

Referring now to FIG. 2, a flowchart illustrating an exemplary process 200 for communicating the service level expectations of customer 102 to hospitality worker 104, according to an aspect of the present disclosure, is shown.

Process 200, which may execute within system 100, begins at step 202 with control passing immediately to step 204.

At step 204, customer 102 enters a hospitality establishment, such as a restaurant. System 100 may be alerted to this occurrence via mobile device 106 being carried by customer 102. Mobile device 106 equipped with an application in accordance with the present disclosure may first detect its location via GPS, Wi-Fi, Bluetooth, or similar communication means. Upon detection that mobile device 106 has entered the hospitality establishment, a software module within mobile device 106 may alert system 100 of such an occurrence. In another aspect, upon detection that mobile device 106 has entered the hospitality establishment, customer 106 is prompted to share this event with other portions of system 100 or to inform hospitality workers 104 at the hospitality establishment that customer 102 is utilizing an application in accordance with the present disclosure. Notifying hospitality workers 104 in such a manner facilitates utilization of system 100 and execution of process 200. In another aspect, hospitality workers 104 may ask customer if they are using an application in accordance with the present disclosure in order to facilitate utilization of system 100 and execution of process 200.

In step 206, system 100 receives service level preferences from customer 102. Service level preferences include, but are not limited to: customer preferences regarding hospitality worker attentiveness; obtrusiveness; number of times hospitality worker 104 checks in with customer 102 during the course of service; customer desire to receive recommendations regarding food or drink choice; and the like. Such information may be represented by a number (e.g., a number between zero and five) or other indicator (e.g., location of a slider on a scale) input by customer 102 which represents the level of attention they desire.

Service level preferences may be received from customer 102 via a GUI contained in computing device 106. Computing device 106 may be a personal mobile device, such as a smartphone, carried by customer 102. In another aspect, computing device 106 is a handheld computing device supplied to customer 102 at the beginning of service (e.g., when customer 102 is initially taken to his table). In yet another aspect, computing device 106 is a kiosk installed at the hospitality establishment (e.g., a touchscreen-equipped kiosk installed at a restaurant table).

Service level preferences received in step 206 may be stored in user database 122. In user database 122, the received service level preferences are associated with information related to customer 102, such as the customer user account, or the phone number of computing device 106 which generates the service level preference. In an aspect, customer 106 creates a user profile within system 100 which stored service level preferences are associated with. Such service level preferences may be sent automatically when customer 102 enters a hospitality establishment and received in step 206.

In step 208, system 100 receives gratuity level information from customer 102. Gratuity level may be specified as a percentage gratuity of the final bill (e.g., 12%), a value amount (e.g. $10), or a range (e.g., 12 to 25%, $5 to $10). In an aspect, gratuity level information is a minimum amount customer 102 commits to providing if customer 102 receives the service specified in step 206.

Gratuity level may be received from customer 102 via a GUI contained in computing device 106. Computing device 106 may be a personal mobile device, such as a smartphone, carried by customer 102. In another aspect, computing device 106 is a handheld computing device supplied to customer 102 at the beginning of service (e.g., when customer 102 is initially taken to his table). In yet another aspect, computing device 106 is a kiosk installed at the hospitality establishment (e.g., a touchscreen-equipped kiosk installed at a restaurant table).

Gratuity level received in step 208 may be stored in user database 122. In user database 122, the received gratuity level is associated with information related to customer 102, such as the customer user account, service level preferences, or the phone number of computing device 106 which generated the gratuity level. In an aspect, customer 106 creates a user profile within system 100 which stored gratuity levels are associated with. Such gratuity levels may be sent automatically when customer 102 enters a hospitality establishment and received in step 206.

In an aspect, system 100 presents customer 102 with rewards (e.g., points) for specifying a generous gratuity level (e.g., 22%) in order to encourage customer 102 to compensate hospitality worker well. Other monetary and non-monetary rewards may be given, as will be apparent to those having skill in the relevant art(s) after reading the description herein.

In another aspect, step 208 is executed but step 206 is not. A gratuity level is received from customer 102 at computing device 106 and subsequently presented to hospitality worker 104. Hospitality worker 104 may specify the service levels available at the gratuity level received. Specified service levels may be presented to customer 102 via computing device 106. Customer 106 may select one of the available service levels which is then presented to hospitality worker 104 via system 100.

After steps 206 and 208 are performed, hospitality worker 104 receives information provided in steps 206 and 208 and carries out service in accordance with the received service level preferences.

In step 210, customer 102 determines if the services rendered by hospitality worker 104 were delivered in accordance with the service level preferences input by customer 102 in step 206.

If determining step 210 is positive, step 214 executes. In step 214, customer 102 provides hospitality worker 104 with a gratuity based on the gratuity level specified in step 208. For example, if customer 102 specified a gratuity level of >15% in step 208, customer 102 may provide hospitality worker 104 with a gratuity of 18%.

If determining step 210 is negative, step 212 executes. In step 212, customer 102 may deviate from the gratuity level specified in step 208. For example, if customer 102 specified a gratuity level of >15% in step 208, but receives service below the service level preferences specified in step 206, customer may choose to provide hospitality worker 104 with a gratuity of 12%. It should be noted that, where determining step 210 is negative, customer may also choose to still provide a gratuity at the gratuity level specified in step 208 or to provide a gratuity at a high level. The latter instance may occur where hospitality worker 104 provides service above the service level preference specified in step 206 in a manner pleasing to customer 102.

Process 200 then terminates at step 216.

Throughout the service, customer 102 may request hospitality worker's 104 presence via computing device 106 via, for example, pressing a service request button presented by GUI 518.

The tip ranges in process 200 and in other portions of the present disclosure may be revealed to worker 104 before service begins, during service, or after service has been completed.

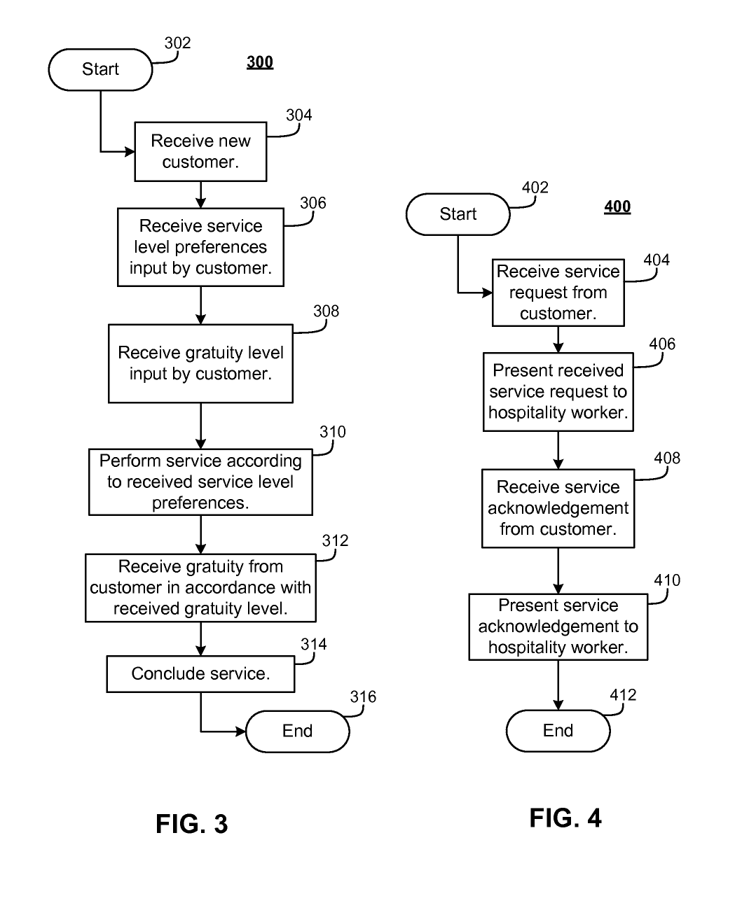

Referring now to FIG. 3, a flowchart illustrating an exemplary process 300 for hospitality industry worker 104 to execute service based on received service level expectations, according to an aspect of the present disclosure, is shown.

Process 300, which may be carried out on portions of system 100, begins at step 302 with control immediately passing to step 304.

At step 304, hospitality worker 104 receives a new customer. For example, where hospitality worker 104 is a restaurant server, new customer 102 may be seated in hospitality worker's section. Hospitality worker 104 then determines if customer 102 wishes to utilize systems, methods, or computer program products in accordance with the present disclosure. If customer 102 wishes to do so, process 300 continues.

In step 306, hospitality worker 104 receives, via computing device 106, service level preferences input by customer 102. Service level preferences may be input according to step 206 of process 200, which may run concurrently to process 300.

In step 308, hospitality worker 104 receives, via computing device 106, gratuity level input by customer 102. In this manner, hospitality worker 104 is apprised in advance of the income expected from customer 102 and the criteria necessary to earn such income, thereby eliminating the stress of uncertainty regarding performance expectations and compensation. Gratuity level may be input according to step 208 of process 200, which may run concurrently to process 300.

In another aspect, hospitality worker 104 receives service level preferences and gratuity levels input by customer 102 at a desktop-based or tablet-based computing device 106 positioned away from customer's 102 table or other location within the hospitality establishment.

In step 310, hospitality worker 104 performs services for customer (e.g., waiting on them during a meal at a restaurant) in accordance with the service level preferences specified (e.g., do not recommend dessert, ensure that no one's glass drops below half full).

In step 312, after performing services in accordance with the service level preferences specified, hospitality worker 104 receives a gratuity in accordance with the specified gratuity level. Gratuity may be given via cash, via credit card processed via system 100, via credit card processed by the hospitality establishment's credit card processor, or by some other method apparent to those having skill in the relevant art(s) after reading the description herein.

In step 314, the service is concluded and process 300 terminates at step 316.

Referring now to FIG. 4, a flowchart illustrating an exemplary process 400 for hospitality industry worker 104 to execute service based on received service requests, according to an aspect of the present disclosure, is shown.

Process 400, which may be carried out on portions of system 100, begins at step 402 with control immediately passing to step 404.

At step 404, system 100 receives a service request from customer 106 via computing device 106 accessible by customer 102. The service request may be a request for additional napkins, a drink refill, a dessert menu, and the like.

In step 406, hospitality worker 106 is notified of and presented with the service request received in step 404. Hospitality worker 104 may be informed of such a request by audio, visual, or physical (e.g., vibration) alerts generated by a mobile device or other computing device 106 accessible by hospitality worker 104.

Upon receipt of the service request, hospitality worker performs the necessary service for customer 102 and, in step 410, customer 102 or hospitality worker 104 inputs a task complete command into system 100, indicating that the service request has been addressed. Hospitality worker 104 is then presented with an acknowledgement of service completion.

Process 400 then terminates at step 412.

During the course of service, customer 102 may input real-time gratuity increases or decreases to provide hospitality worker 104 with real-time feedback of performance. For example, customer 102 may, via mobile device 102 increase the gratuity level specified for hospitality worker 104 in response to speedy service.

Upon completion of service, aspects of the present disclosure may prompt customers 102 to complete a review of the performance of hospitality worker 104. Such reviews may be stored in user database 122 for future examination and use by managers, hospitality worker 104, customers 102, or potential employers. Completion of such a review may give customers reward points which could be exchanged at an internet-based mall for prizes. As will be apparent to those skilled in the relevant art(s) after reading the description herein, such points may be redeemed via other systems.

Reviews and other information about worker 104, including information provided by customer 102, reviews, and the like may be stored. Such stored information may be compiled into a hospitality worker resume via infrastructure 101 and accessed by worker 104 or a third party via a computing device. In this manner, the present disclosure provides a resume or list of reviews about worker 104 provided by third parties, creating an objective review system.

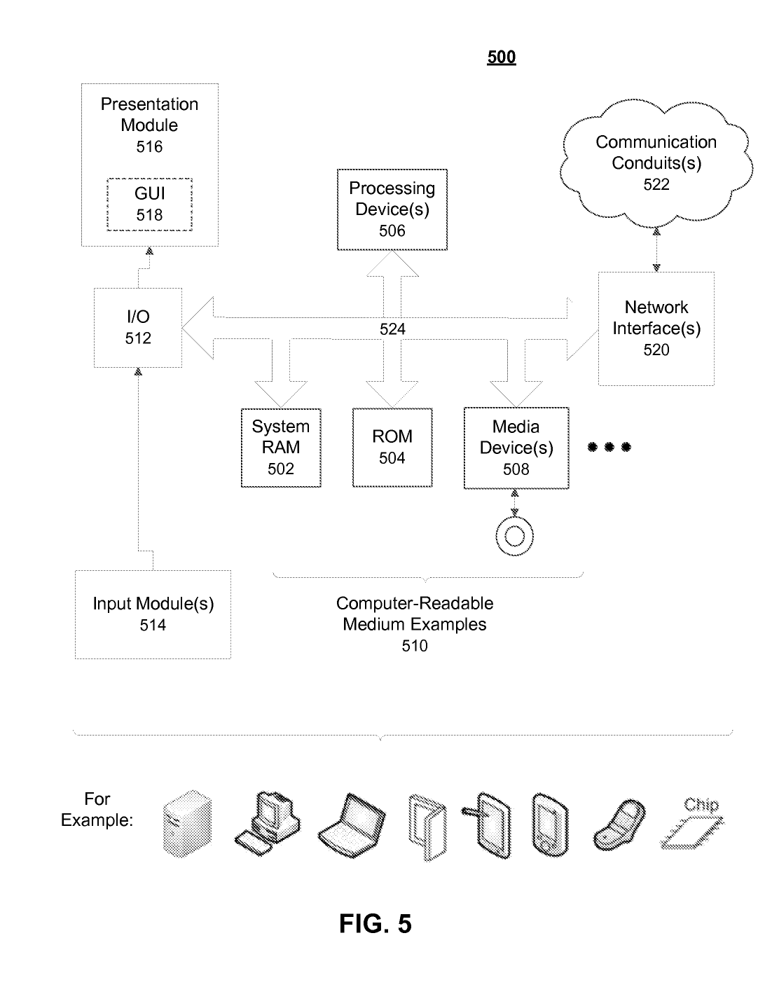

Referring now to FIG. 5, a block diagram of an exemplary computer system useful for implementing various aspects the processes disclosed herein, in accordance with one or more aspects of the present disclosure, is shown.

That is, FIG. 5 sets forth illustrative computing functionality 500 that may be used to implement web server 110, one or more gateways 112-120, user database 122, establishment database 124, computing devices 106 utilized by customers 102 and/or hospitality workers 104, or any other component of system 100. In all cases, computing functionality 500 represents one or more physical and tangible processing mechanisms.

Computing functionality 500 may comprise volatile and non-volatile memory, such as RAM 502 and ROM 504, as well as one or more processing devices 506 (e.g., one or more central processing units (CPUs), one or more graphical processing units (GPUs), and the like). Computing functionality 500 also optionally comprises various media devices 508, such as a hard disk module, an optical disk module, and so forth. Computing functionality 500 may perform various operations identified above when the processing device(s) 506 execute(s) instructions that are maintained by memory (e.g., RAM 502, ROM 504, and the like).

More generally, instructions and other information may be stored on any computer readable medium 510, including, but not limited to, static memory storage devices, magnetic storage devices, and optical storage devices. The term “computer readable medium” also encompasses plural storage devices. In all cases, computer readable medium 510 represents some form of physical and tangible entity. By way of example, and not limitation, computer readable medium 510 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 502, ROM 504, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 500 may also comprise an input/output module 512 for receiving various inputs (via input modules 514), and for providing various outputs (via one or more output modules). One particular output module mechanism may be a presentation module 516 and an associated GUI 518. Computing functionality 600 may also include one or more network interfaces 520 for exchanging data with other devices via one or more communication conduits 522. In some embodiments, one or more communication buses 524 communicatively couple the above-described components together.

Communication conduit(s) 522 may be implemented in any manner (e.g., by a local area network, a wide area network (e.g., the Internet), and the like, or any combination thereof). Communication conduit(s) 522 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

What is claimed is:

1. A computer-implemented method of evaluating and compensating hospitality workers, the method comprising the steps of:
(a) receiving, via a customer computing device, service level information, the service level information indicating, during a hospitality service, a preferred hospitality worker attentiveness level and a gratuity level, the gratuity level corresponding with the preferred hospitality worker attentiveness level;
(b) storing, in an establishment database communicatively coupled to the computing device, the received service level information;
(c) presenting, via a hospitality worker computing device, at least one customer service level requirement related to received service level information;
(d) presenting, via the hospitality worker computing device, the received gratuity level;
(e) receiving an indication from the customer that the service level corresponding to the hospitality service was satisfied; and
(f) prompting, via the customer computing device, the customer to initiate a gratuity payment to the hospitality worker, the gratuity payment corresponding with the received gratuity level.

2. The method of claim 1, wherein receiving step (a) and storing step (b) are performed when the customer enters an establishment.

3. The method of claim 1, wherein the gratuity level is adjustable during the hospitality service based on a received hospitality worker service quality.

4. The method of claim 1, wherein the service level information further comprises at least one customer diet restriction.

5. The method of claim 1, wherein the service level information further comprises at least one of: a quick lunch request; a notification of the customer being on a date; a notification of the customer celebrating a special event; a desire to receive service-related recommendations, such as food and beverage recommendations; service-related aspects the customer prefers to avoid, such as not having the customer's beverage level drop by more than 50% without getting a refill; and a notification of the customer being with business colleagues.

6. The method of claim 1, further comprising:
(f) receiving, via the customer computing device, evaluative feedback.

7. The method of claim 8, wherein the customer earns reward points for providing the received evaluative feedback.

8. The method of claim 1, wherein a customer computing device user interface comprises a service request mechanism, the method further comprising the steps of:
(f) receiving, via the service request mechanism, a customer service request; and
(g) presenting the received customer service request to the hospitality worker.

9. The method of claim 8, wherein the customer service mechanism is one of: a button; a check box; a detected customer gesture; and an audio recording.

10. The method of claim 8, wherein the received customer service request is presented via the hospitality worker computing device.

11. A system for enhancing communication between a customer and a hospitality worker, the system comprising:
(a) at least one web server capable of providing a graphical user interface, via a communications network, to at least one customer computing device and at least one hospitality worker computing device;
(b) an establishment database, communicatively coupled to the at least one web server via the communications network; and (c) at least one application server, communicatively coupled to the at least one web server via the communications network, the at least one application server comprising:
(i) a service level collections module capable of receiving service level information from the at least one customer computing device, the service level information indicating, during a hospitality service, a preferred hospitality worker attentiveness level and a gratuity level, the gratuity level corresponding with the preferred hospitality worker attentiveness level;
(ii) a hospitality worker module capable of communicating, via the at least one hospitality worker computing device, at least one customer service level requirement related to received service level information and the received gratuity level; and
(iii) a reconciliation module capable of receiving an indication from the customer that the service level corresponding to the hospitality service was satisfied and prompting a gratuity payment to the hospitality worker, the gratuity payment corresponding with the received gratuity level.

12. The system of claim 11, wherein the at least one hospitality worker computing device is a point-of-sale system within an establishment.

13. The system of claim 11, wherein the at least one customer computing device is a customer smartphone.

14. The system of claim 11, wherein the at least one customer computing device is provided by an establishment providing the hospitality service.

15. One or more computer storage media having stored thereon multiple instructions that facilitate evaluating and compensating hospitality workers by, when executed by one or more processors of a computing device, causing the one or more processors to:
a) receive, via a customer computing device, service level information, the service level information indicating, during a hospitality service, a preferred hospitality worker attentiveness level and a gratuity level, the gratuity level corresponding with the preferred hospitality worker attentiveness level;
(b) store, in an establishment database communicatively coupled to the computing device, the received service level information;
(c) present, via a hospitality worker computing device, at least one customer service level requirement related to received service level information;
(d) present, via the hospitality worker computing device, the received gratuity level;
(e) receive an indication from the customer that the service level corresponding to the hospitality service was satisfied; and
(f) prompt, via the customer computing device, the customer to initiate a gratuity payment to the hospitality worker, the gratuity payment corresponding with the received gratuity level.

16. One or more computer storage media as recited in claim 15, wherein the multiple instructions further cause one or more processors to:
(g) receive, via the customer computing device, evaluative feedback.

17. One or more computer storage media as recited in claim 15, wherein a customer computing device user interface comprises a service request mechanism, the multiple instructions further cause one or more processors to:
(f) receive, via the service request mechanism, a customer service request; and
(g) present the received customer service request to the hospitality worker.

18. One or more computer storage media as recited in claim 15, wherein the received customer service request is presented via the hospitality worker computing device.

19. One or more computer storage media as recited in claim 15, wherein the gratuity level is adjustable during the hospitality service based on a received hospitality worker service quality.

20. One or more computer storage media as recited in claim 15, wherein the customer computing device is provided by an establishment providing the hospitality service.
